(19) United States
(12) Patent Application Publication
(10) Pub. No.: US 2026/0147846 A1
(43) Pub. Date: May 28, 2026

(54) IDENTIFICATION OF TYPOSQUAT DOMAIN VARIATIONS IN PASSIVE DOMAIN NAME SYSTEM (PDNS)

(71) Applicant: Infoblox Inc., Santa Clara, CA (US)

(72) Inventor: Christopher June Kim, Puyallup, WA (US)

(21) Appl. No.: 19/175,980

(22) Filed: Apr. 10, 2025

Related U.S. Application Data
(60) Provisional application No. 63/726,160, filed on Nov. 27, 2024.

(51) Int. Cl. G06F 16/9536; G06F 16/906; H04L 9/40

(52) U.S. Cl. CPC G06F 16/9536; G06F 16/906; H04L 63/1416

(57) ABSTRACT

Various techniques for identification of typosquat variations in passive domain name systems (pDNS) are disclosed. In some embodiments, a system, a process, and/or a computer program product for identification of typosquat variations in pDNS includes generating a plurality of candidate typosquat domains using a virtual keyboard; automatically classifying a subset of the plurality of the candidate typosquat domains that each have been previously queried based on Domain Name System (DNS) logs to generate targeted candidate typosquat domains, wherein the classifying includes at least in part performing a Euclidean distance calculation using the virtual keyboard as a plane; and performing an action for one or more of the targeted candidate typosquat domains.

### CROSS REFERENCE TO OTHER APPLICATIONS

This application claims priority to U.S. Provisional Patent Application No. 63/726,160 entitled IDENTIFICATION OF TYPOSQUAT DOMAIN VARIATIONS IN PASSIVE DOMAIN NAME SYSTEM (PDNS) filed Nov. 27, 2024, which is incorporated herein by reference for all purposes.

### BACKGROUND OF THE INVENTION

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain.

### BRIEF DESCRIPTION OF THE DRAWINGS

Various embodiments of the invention are disclosed in the following detailed description and the accompanying drawings.

FIG. 1 is a table of descriptions for popular lookalike attack forms used in the threat landscape and referred to by security researchers.

FIG. 2 illustrates a system architecture that shows the flow of data between different components of the typosquat identification and processing system (TIPS) and showing how candidate typosquat domains are refined throughout production during the TIPS production process in accordance with some embodiments.

FIG. 3 provides examples of typosquat domain variations.

FIG. 4 illustrates a process performed by TIPS for discovering and filtering SLD typosquat candidate domains in accordance with some embodiments.

FIG. 5 provides an example of actual UK government domains that we discovered in pDNS in accordance with some embodiments.

FIG. 6 provides an example of actual Nike sponsored TLD domains that we discovered in pDNS in accordance with some embodiments.

FIG. 7 provides an example of the Euclidean distance formula in two dimensions in accordance with some embodiments.

FIG. 8 illustrates a virtual representation of the non-shifted English QWERTY keyboard layout excluding invalid DNS characters in accordance with some embodiments.

FIG. 9 illustrates a Python function for computing the cost of an insert action against a target seed label in accordance with some embodiments.

FIG. 10 Illustrates a Python function for control checking typosquat candidate domains based on typo cost and action ratio measures in accordance with some embodiments.

FIG. 11 provides a mathematical representation of calculating all possible subsequences with repeatable elements given an iterable object in accordance with some embodiments.

FIG. 12 illustrates a functional block diagram for automatically generating a DNS fingerprint for a domain in accordance with some embodiments.

FIG. 13 shows a multi-Domain SAN certificate showing generic TLD domains owned by the Philippines government.

FIG. 14 illustrates how to automatically perform word identification via lexicographic permutation in accordance with some embodiments.

FIG. 15 is a table that includes typosquat archive probability rating measures in accordance with some embodiments.

FIG. 16 is a flow diagram of a process for identification of typosquat variations in a passive domain name system (pDNS) in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names (FQDNs)). Web addresses are translated into IP addresses. The Domain Name System (DNS) translates domain names, which can themselves be web addresses, to IP addresses. Specifically, requests including web addresses are sent to DNS servers that generally reply with corresponding IP addresses or with an error message in case the domain has not been registered, a non-existent domain (e.g., an NX Domain response is returned by DNS servers for a non-existent domain).

### Technical Challenges for DNS Security

A typosquat domain is one that might easily be mistyped by a user and often has a visual similarity to an original domain. There is a long history of registering typosquat domains for a variety of purposes. Within the context of threat intelligence, domain typosquatting is a set of techniques used by cybercriminals to target and misroute internet users that incorrectly type website addresses into their web browsers. This method exploits natural typographical keyboard mistakes of humans and involves registering domains with the same name labels created from such mistakes. As such, new and improved techniques for automatically discovering such improperly and/or nefariously registered typosquat domains are disclosed as will be further described below.

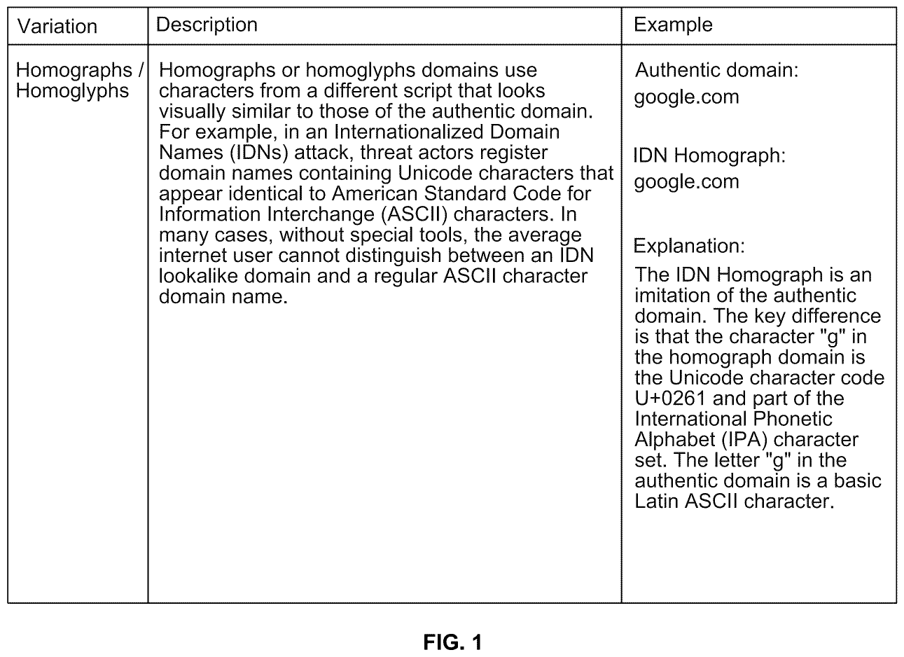

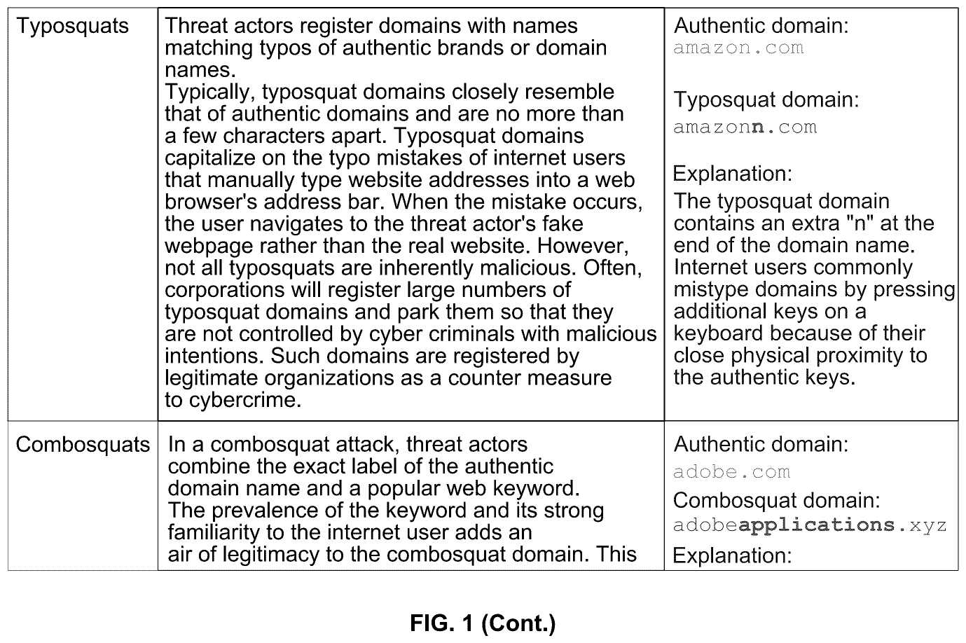

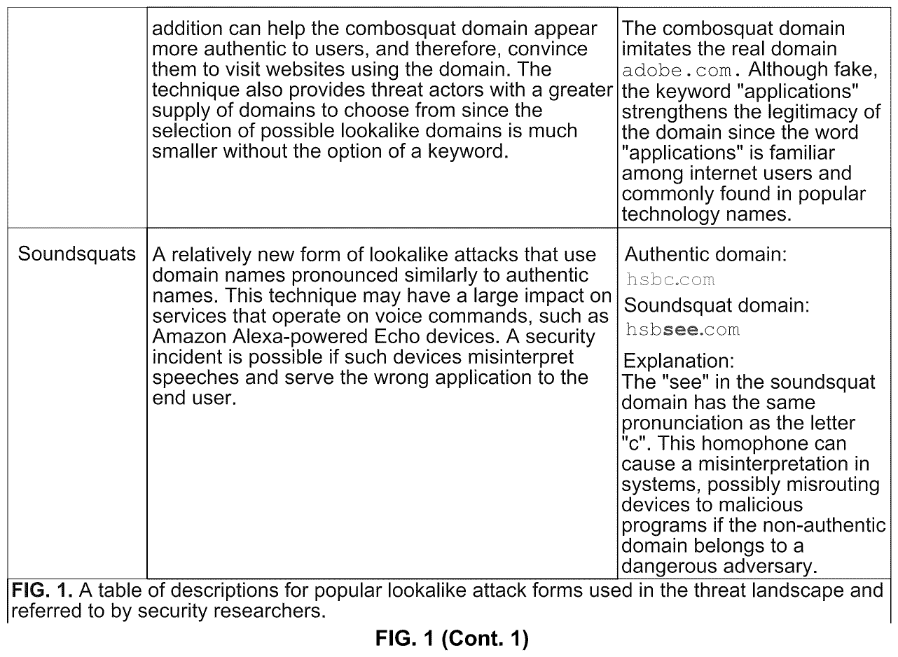

A typosquat domain is a subvariant of a lookalike domain, a fake domain name that imitates the visual qualities of an authentic brand or website name. Lookalike domains are key attack vectors for threat actors and effective phishing lures that attract web clicks from unsuspecting internet users. Due to its low technical barrier for usage, as well as its great synergy with other social engineering attacks, threat actors commonly deploy this approach in their cyber campaigns. There are numerous and different forms of lookalike domains; the following types in FIG. 1 are some of the more recognized forms in the cybersecurity industry.

FIG. 1 is a table of descriptions for popular lookalike attack forms used in the threat landscape and referred to by security researchers.

From the threat actor's perspective, a unique advantage of the typosquatting is that it trivially obtains web traffic from Internet users. The volume of inbound traffic to the domain is typically larger the more spatially (e.g., on a computer keyboard) close the typosquat domain is relative to the authentic domain. This is because the likelihood that a user mistypes a domain is greater the smaller the spatial distance is between the typosquat and the authentic domain.

This advantage enables an actor to collect potential victims with less time and resources compared to some other lookalike approaches. To gather an audience, actors need to advertise their lookalike domain after they have registered and configured the domain. This is usually done by sending spam emails to large user groups, or performing search engine optimization (SEO) advertising, or selecting a well-known advertising network to promote the newly created and fraudulent website. This is all time-consuming practices and costly investments that a typosquat threat actor does not necessarily require.

### Example Embodiments for Identification of Typosquat Variations in a Passive Domain Name System (PDNS) Using DNS Fingerprints, Spatial Analysis, and Intelligent Word-Based Filtering

Existing approaches to detecting typosquat domains are inadequate.

Accordingly, new and improved techniques for automatically detecting typosquat domains are disclosed.

In some embodiments, a system, a process, and/or a computer program product for identification of typosquat variations in passive domain name systems (pDNS) using DNS fingerprints, spatial analysis, and intelligent word-based filtering is disclosed with respect to various embodiments as further described below.

In an example implementation, a typosquat identification and processing system (TIPS) is disclosed. TIPS solves a key problem that many organizations face and that is awareness of internally owned domains. This problem is more severe with large enterprises that own thousands if not tens of thousands of domains, because managing so many domains generally requires high discipline, as well as a large and technical information technology (IT) team. TIPS can automatically compile target domains (e.g., authentic domains that belong to a legitimate entity) that are relevant to an organization. The disclosed techniques are unique, at least in part, because other typosquat detection approaches commonly rely on target domain inputs manually defined by a user. Furthermore, TIPS provides cost-effective solutions to businesses by suggesting registration of the most impactful typosquat domains to their brand. This gives an opportunity for businesses to claim/protect/register domains before they are purchased by cyber criminals.

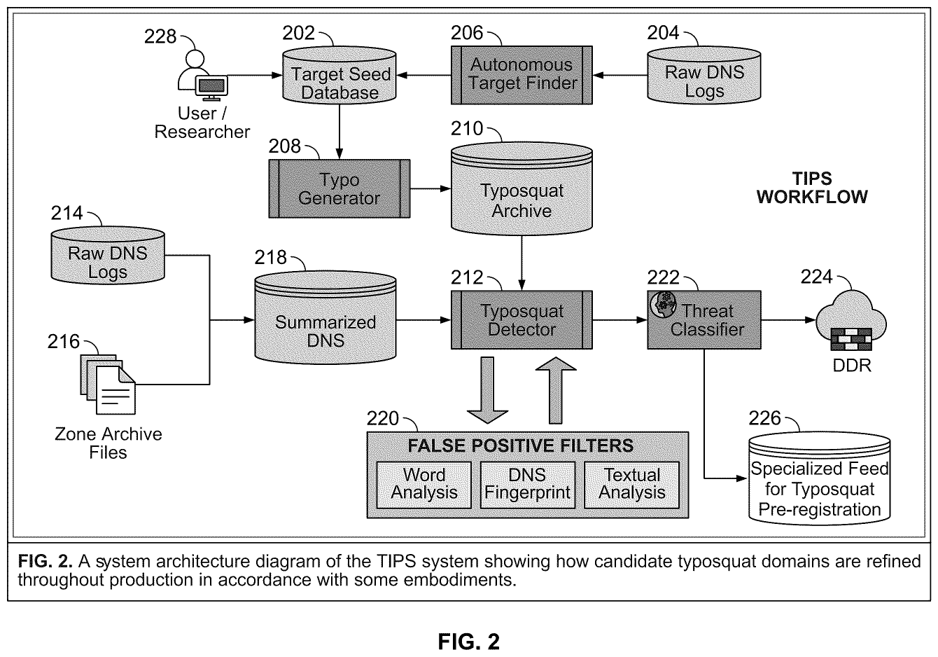

The intelligence generated from the TIPS is most effective, but not limited to, when used by a DNS Detection and Response (DDR) system (e.g., as shown at 224 in FIG. 2 which receives threat classifications from threat classifier 222 as shown at 222), also referred to as a protective DNS system. It uses DNS-focused upstream data sources, such as passive DNS and top-level domain (TLD) zone archives, to identify typosquat domains that have either been activated for criminal use or registered and pending deployment. This enables the disclosed TIPS system to find the most relevant domains and improve sustainability in a DDR system that is limited in data capacity.

In an example implementation, TIPS uses a highly scalable and accurate model that enables it to detect any newly updated or created domain, and then assess whether it is a typosquat. It uses a large collection of DNS data to achieve a high detection rate and capture the majority of typosquat domains that are used maliciously within the threat landscape. With minimal false positives (FPs), TIPS discovers four variations of typosquats that are further explained below: (1) typosquats, (2) zero-cost typosquats, (3) zero-cost combosquats, and (4) combo typosquats. The diversity in the detection results helps organizations that use the intelligence to protect themselves against common cybercrime, as well as more sophisticated attacks, such as advanced persistent threats (APT).

Specifically, in an example implementation, TIPS is a DNS-based and highly scalable system that identifies different variations of typosquat domains, using a combination of spatial distance techniques (e.g., calculating the Euclidean distance between a candidate and authentic domain, using various language keyboards, such as QWERTY, as the plane), word analysis, DNS analytics, and an extensive multi-stage false positive (FP) filtering process. It is also a low-maintenance and self-sustaining model that can autonomously grow the size of its target seed and authentic domains that we monitor for, for example, trademark abuse. A powerful and rare feature of TIPS is the capability to automatically identify related domains to individual organizations on its own without support from a human user. This is key for automatic expansion of the target seed database, as well as reducing false positives. Additionally, TIPS helps organizations pre-register typosquat domains before malicious threat actors without exceeding their budget limits.

The collective techniques and features of the disclosed TIPS solution/system make it unique compared to other typosquat detection and classification approaches. Some key and compelling qualities of TIPS include, without limitation, the following:
(1) TIPS identifies typosquat domains in a large pDNS database that originates from many different geographical site locations and organization networks;
(2) TIPS calculates the Euclidean distance between a candidate and authentic domain, using various language keyboards, such as QWERTY, as the plane;
(3) TIPS calculates spatial cost of a typosquat candidate that allows us to grade them and filter accordingly;
(4) TIPS pre-generates potential (e.g., all possible) typosquat domains per target domain seed, and then uses this data to identify real typosquat domains in DNS at scale;
(5) TIPS automatically finds seed domains that are associated with a specific organization or industry;
(6) TIPS identifies four different typosquat variations: regular typosquats, exact label typosquats, combosquats, and combo typosquats;
(7) TIPS uses DNS fingerprints and SAN SSL certificates to determine whether a candidate domain belongs to a legitimate organization, and if so, filters them out from results;
(8) TIPS performs a word analysis (e.g., an intelligent word analysis) to determine if a high spatial cost candidate shows a contextual change;
(9) using TIPS, pre-generated typosquat labels are archived optimally by clustering files around important data keys that are dynamically adjusted based on query patterns; and/or
(10) TIPS automatically recommends domain registrations for typosquat domains that have the highest probability of occurring due to natural human typo mistakes.

In some embodiments, a system architecture for the TIPS system includes multiple components that work together, in different stages, to automatically identify typosquat domains at scale in DNS (e.g., passive DNS (pDNS)) and with high precision, such as shown in FIG. 2 as will now be described below.

FIG. 2 illustrates a system architecture that shows the flow of data between different components of the typosquat identification and processing system (TIPS) and showing how candidate typosquat domains are refined throughout production during the TIPS production process in accordance with some embodiments. An element of the system and starting point for the pipeline is the target seed database 202. This storage is updated incrementally and based on manual target inputs by users across various organizations (e.g., user/researcher 228), as well as auto-generated targets. A target is an authentic and legitimate domain that organizations wish to protect against brand infringement. When a new target is added for monitoring, TIPS then computes all possible typosquats for that target seed and updates the typosquat archive table, a mapping of targets and their possible typo labels. Next, TIPS searches for real domains that share the same name as the typo labels in the typosquat archive table. A domain is real if it shows successful responses in historical logs of DNS queries (e.g., raw DNS logs 214) that are based on natural business network activity. The domain is also real if it exists in public zone files (e.g., zone archive files 216), text files maintained by registry operators (e.g., Verisign and/or other commercial registry operators), and containing a map of domain names to their DNS RRs. Subsequently, the TIPS detector (e.g., as shown at 212 in FIG. 2) joins a DNS table, built by a separate DNS analytics system and containing real domains or real fully qualified domains (FQDN) with relevant metadata, with the typo archive to find domains that are truly resolving in DNS or registered. Later, these detections are filtered via a multi-step false positive (FP) reduction process (e.g., using false positive filters as shown at 220 in FIG. 2) that makes decisions based on the candidate domain's attributes, as well as the context derived from its text name label. Finally, the TIPS threat classifier 222 uses relevant threat intelligence, such as website artifacts, file properties, and reputation of Internet attributes, to accurately classify the filtered typosquat domains, such as phishing, spam, lame, parked, suspicious, or generic.

Although the intelligence from the system is ideal for a DDR service/solution, it is also highly effective and efficient in other security services/solutions, such as HTTP URL filtering. Moreover, the intelligence produced by TIPS can provide large coverage for threat intelligence. The DNS data source is drawn from thousands of networks across millions of Internet users. TIPS can also operate at a very large data scale, because it uses computationally efficient processes and only selects relevant domains for typosquat assessments, such as will be further described below.

### Typosquat Variations

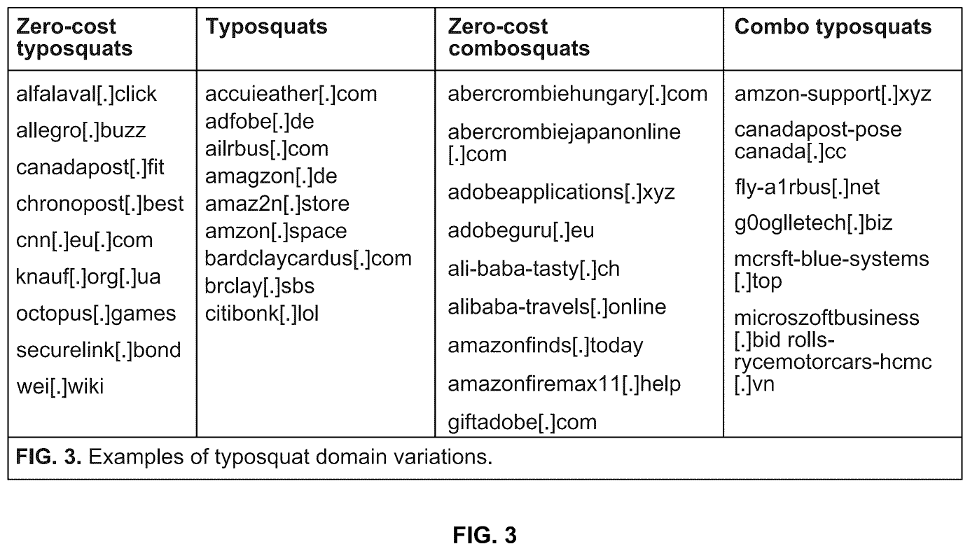

FIG. 3 provides examples of typosquat domain variations.

As briefly discussed above, TIPS can identify four different variations of typosquat domains: (1) zero-cost typosquats, (2) typosquats, (3) zero-cost combosquats, and (4) combo typosquats. As will now be further described below, each form is calculated and filtered differently. In addition, each kind also uniquely protects organizations that incorporate the data in their DDR systems. The following is an explanation of their formulas, and FIG. 3 provides examples of their results, as will be further described below.
(1) Zero-cost typosquats: Zero-cost typosquats is used to generally refer to domain names that have a zero Euclidean distance relative to the authentic domain. In other words, the name label of the authentic domain exactly matches the name label of the typosquat domain. These domains do not require extra filters for false positive reduction. The domains are sourced from a DNS summary table and already vetted as newly seen domains. Such domains are not popular in networks from a near term perspective and cause minimal business impact even if they were found to be false positives in the future. The domains also expire out of DDR feeds after their defined time to live (TTL), which is typically set less than six months.
(2) Typosquats: Typosquats is used to generally refer to domain names that include a typo of the authentic domain label. The typo mistake does not alter the domain name in a way that its spatial distance from the authentic domain exceeds a predetermined maximum threshold for the spatial distance, such as will be further described below. In an example implementation, no further filters are applied on the typosquat domains, because they are mathematically proven to be typosquats regardless of whether their meanings have changed because of the typo (e.g., anagrams). In a real cyber-attack, for example, threat actors configured the domain docusong.com as a command-and-control for their malicious version of Cobalt Strike, a cyber security penetration testing tool. This domain is an imitation of docusign.com, a domain that belongs to a technology company specializing in electronic signature services. Although the label docusong represents a different meaning compared to the authentic name docusign, its typosquat classification is mathematically accurate. The threat actors selected and registered docusong.com, because the probability that the user mistypes docusign as docusong is relatively high.
(3) Zero-cost combosquats: This variation is used to generally refer to domain names with a zero-cost typosquat label concatenated with a keyword. For example, threat actors often select technology or finance keywords that are commonly known and compelling to Internet users. For example, these can include the labels: support, helpdesk, service, system, cloud, invoice, and receipt (e.g., and/or various other labels).
(4) Combo typosquats: A combo typosquat domain label is used to generally refer to domain names that include the combination of a typosquat (e.g., a misspelled name) and a keyword. This form is generally less common in DNS than the other typosquat versions. However, it is used by both common and sophisticated threat actors, such as those sponsored by nation states.

### Typosquat Identification, Filtration, and Classification

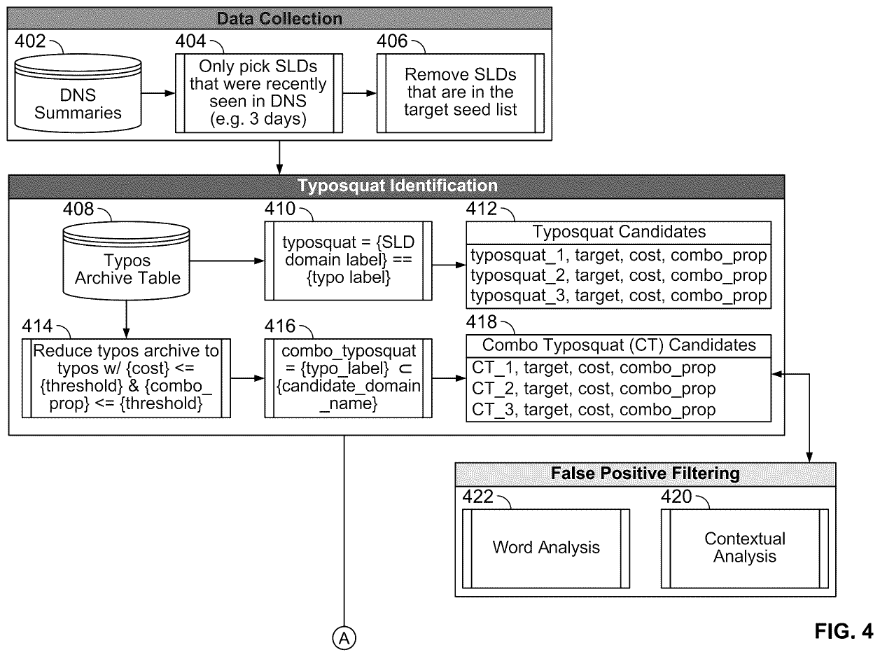

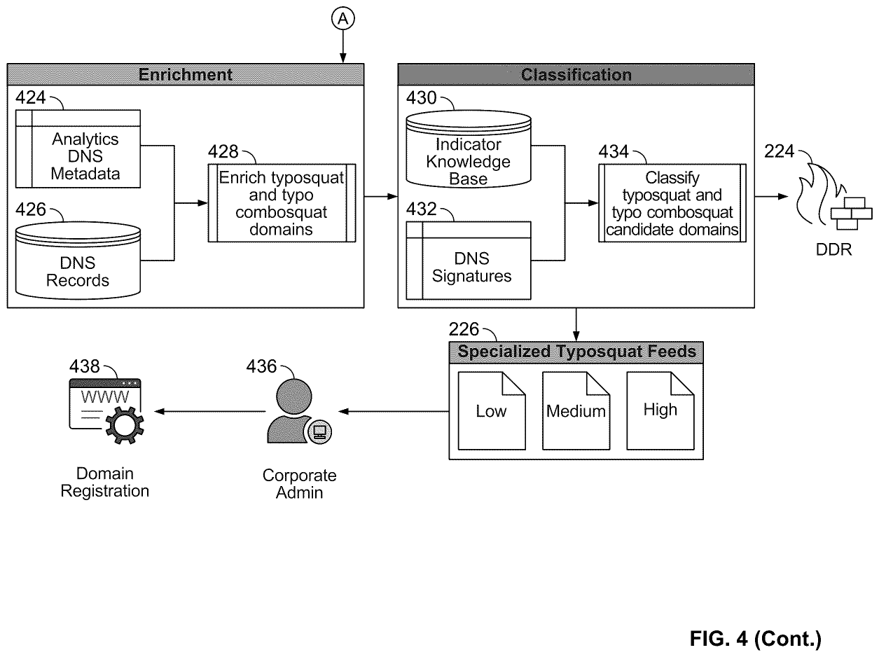

FIG. 4 illustrates a process performed by TIPS for discovering and filtering SLD typosquat candidate domains in accordance with some embodiments. Enterprises use the final product in their DDR systems for threat protection at the DNS level. Separately, they may opt to proactively register typosquat domains in accordance with some embodiments.

TIPS automatically detects typosquats at multiple levels of the domain hierarchy including second-level domains (SLD) and subdomains, or hostnames. The disclosed TIPS system is versatile and can identify SLDs regardless of what top-level domain (TLD) it uses. The number of sub labels in a domain is also irrelevant and TIPS is capable of finding highly nested subdomains (e.g., sub7.sub6.sub5.sub4.sub3.sub2.sub1.{malicious_domain_label}.{TLD}). Both approaches follow different steps for identification, data refinement, and threat classification. These are explained further below with respect to various embodiments.

### Example: SLD Process Steps

Generally, the majority of typosquat SLDs that are used in cyber-attacks are either inherently malicious and created by the threat actor, or pre-registered by trademark owners to hold the domain and prevent it from being misused by adversaries. The objective of TIPS is to discover typosquats accurately without misclassifying the pre-registered and corporate-owned domains as malicious. To accomplish this, TIPS uses statistically summarized DNS datasets (e.g., as shown at 218 in FIG. 2) and an archive database containing all possible typo labels per target seed. It then carefully evaluates candidate domains via a false positive filtration workflow (e.g., using false positive filters, such as shown at 220 in FIG. 2) that can effectively detect indications of anagram variants.

The following is a textual description of FIG. 4, which visually explains the workflow steps (e.g., process operations that can be performed using the disclosed TIPS system) as will now be described below.
(1) Fetch newly seen SLDs across the networks we monitor (404) from a DNS Summaries data store (402). The benefit of starting with newly seen domains is twofold: (i) we can work with old domains because their short history in DNS implies it has minimal impact to critical services; and (ii) such can facilitate the TIPS system filtering out duplicate domain detections that may reduce system performances with additional overhead.
(2) Join the dataframe containing newly seen SLDs with the typos archive table (e.g., programmatically in pyspark, this would be newly_seen_slds.join(typos_archive, newly_seen_slds.sld_name==typos_archive.typo_label, how=‘inner’)) (410). The result is a dataframe containing domains that we have proven to be mathematically typosquat domains (412).
(3) Create a separate copy of the typos archive table, but filter for typo labels that have a spatial cost less than or equal to three and a combination proportion value of less than or equal to, in this example implementation, 0.1 (414). This table is used for identifying combo typosquat domains (416). The number of cybercrime instances involving a combo typosquat is miniscule compared to other variations. Based on experiments, this filtering technique captures the vast majority of combo typosquat domains used in the threat landscape.
(4) Filter for newly seen SLDs whose name labels include any of the typo labels calculated from stage (3) as described above. In other words, the typo label is a proper subset of the SLD name. This is mathematically described as {typo_label}⊂{candidate_domain_name}. We acknowledge a candidate domain that meets this check as a possible combo typosquat domain (418).
(5) In comparison to regular typosquat domains, combo typosquats are typically more spatially distant relative to the authentic domain. Thus, the probability that the combo typosquat is an anagram is generally high. We assess the combo typosquat for any contextual changes (420) by examining its text and multiple word-based analytical filters (422). Depending on the textual transformation and whether it exceeds our thresholds, irrelevant combo typosquat domains are filtered out. The disclosed filtering techniques are described in more detail further below with respect to various embodiments.
(6) Enrich each candidate typosquat and combo typosquat domain with contextual information (428) derived from analytics (424) and DNS observations (426). Examples include their proximity to IP spaces that have been confirmed/verified as malicious, or their DNS records, such as nameservers that could be dedicated to parking services.
(7) Classify the filtered typosquat and combo typosquat domains as malicious, suspicious, spam, parked, or generic (434). The classification is based on confirmed threat intelligence from an indicator knowledge base (IKB) (430) and DNS signatures of known internet infrastructure, malicious, or suspicious behavior (432).
(8) Submit the classified typosquats and combo typosquats to production-level threat intelligence databases. Subsequently, DDR systems (224) download the data for protection against cyber-attacks.
(9) Separately, the typosquat detections can also be segmented/divided by their risk levels (e.g., probability of the typo occurring) and three different feeds (226) can be automatically generated as shown in this example implementation: (i) a high risk feed, (ii) a medium risk feed, and (iii) a low risk feed. In an example implementation, the risk level is based on the typosquat's spatial cost and combo proportion values.

For example, as shown in FIG. 4, a corporate administrator 436 (e.g., or other authorized enterprise user) can utilize the typosquat feeds (226) to register one or more of the typosquat domains to protect their enterprise (e.g., as shown at 438) as similarly described herein.

### Example: FQDN Process Steps

Accurately identifying FQDN typosquats is a more technically challenging task than SLDs, especially if the identification is only based on textual patterns. This is because corporations use many technology services requiring DNS communication. Often, each service requires network administrators to assign a unique and dedicated FQDN. In such cases, the sub-level labels of those FQDNs will contain a trademarked name that is owned by a well-known technology company. A false positive incident is highly likely to occur if a typosquat detector (e.g., as shown at 212 in FIG. 2) labels an FQDN as a typosquat simply because it shows a label identical to a target seed. To mitigate this problem, TIPS examines a combination of features to determine the authenticity of the candidate FQDN typosquat domain. Those features include SLD ranks (e.g., domain popularity), DNS fingerprints, selective targets, and WHOIS registration details. Below is an example set of processing operations provided as a step-by-step approach that TIPS can be configured to implement for FQDN typosquat identification, false positive reduction, and classification.
(1) First, gather the SLDs from the target seed database.
(2) Build a list of popular domains based on the SLD's popularity rank, which is based on cumulative rank-frequency. In an example implementation, a cut-off line is the cumulative distribution function (CDF) value 0.75 (e.g., anything below this example threshold is considered to be popular and a representative of large traffic in most networks).
(3) Then, the DNS fingerprint is computed for every domain in the popular domain and target seed domain dataset.
(4) Any new DNS fingerprints, such as those derived from a DNS configuration update for a domain or new target seed domain, are added to the DNS fingerprint database.
(5) Fetch newly seen FQDNs (e.g., FQDNs seen for the first time in DNS networks within 48 hours). This filter helps us eliminate popular services with a long history.
(6) Additionally, filter out any FQDNs that have received a notable number of DNS queries (e.g., 500). This filter also helps us remove popular and potentially critical services.
(7) Remove FQDNs that represent legitimate applications based on data from the IKB or indicate specialized services (e.g., email security protocols: DKIM, DMARC).
(8) Filter out FQDNs using an SLD that has presence across a large number of different networks. If an SLD is too popular, the greater the likelihood that it has FQDNs assigned to services.
(9) If an FQDN shows an SLD that is dedicated to a webhosting or site building service, we do not filter out the FQDN. Such SLDs are not inherently malicious. However, the FQDN assigned to the service account could be fraudulent and abuse the service.
(10) Target seed SLD names must be greater or equal to five characters long.
(11) Target seed keyword labels (e.g., support) must not be generic and commonly used words. These often overlap with the labels of legitimate FQDN records.
(12) Remove FQDNs of SLDs that show a DNS fingerprint equal to the fingerprint of a popular SLD or target seed SLD (406). A matching fingerprint indicates a high probability that the candidate FQDN is an Internet asset belonging to a legitimate entity.
(13) Identify FQDN typosquat domains by examining each sub label of the FQDN and determine whether it matches a target seed SLD name or any custom target labels.
(14) Additionally, pull in FQDNs containing sublabels that have a subset of the target seed domain name label or target seed keyword label (e.g., combosquats, combo typosquats).
(15) Pass the combosquat FQDN detections through the additional filters that identify contextual changes as will be further described below.
(16) Enrich each FQDN typosquat with contextual information derived from analytics and DNS observations. Examples include their proximity to IP spaces that have been confirmed as malicious, threat classifications based on intelligence from internal databases, or their DNS records, such as nameservers that could be dedicated to parking services.
(17) Classify the FQDN typosquats as, for example, malicious, suspicious, spam, parked, or generic. In an example implementation, the classification is based on confirmed threat intelligence from an indicator knowledge base (IKB) and DNS signatures of known Internet infrastructure, malicious, or suspicious behavior.
(18) In this example implementation, the classified typosquats and combo typosquats can then be submitted to production-level threat intelligence databases. Subsequently, DDR systems can download the data for protection against cyber-attacks.

### TIPS Processes, Functions, and Concepts

Accurate identification of typosquat variations with minimal false positives is a technically challenging task that requires carefully thought-out solutions, as well as the execution order of those solutions (e.g., including processing operations). As described above, a general overview of an example workflow of processing operations for automated typosquat identification and processing at both the SLD and FQDN level is disclosed.

As will now be further described below, the individual techniques and processing functions used by the disclosed TIPS system is disclosed in more detail. Each technique is used by the TIPS system and enables it to generate a high quality and highly precise typosquat output. Holistically, TIPS is a mixture of mathematically computed and heuristically defined functions that start with large datasets of raw DNS data (e.g., as shown at 204 and 214 in FIG. 2), and then sequentially passes processed data as input to another function.

### Target Seed Management

A target seed generally is used to refer to a domain or keyword label and is the starting point for TIPS. This value is a requirement and initiates the first operation in the TIPS system. The seed input is sourced from a few different places: (1) Security administrators across different networks can manually insert domains into the seed database that their organizations wish to protect and monitor; (2) TIPS developers or permitted researchers can manually insert domains into the seed database, as well as keywords commonly used/abused in the threat landscape; and/or (3) TIPS autonomously finds target domains in pDNS that are highly relevant to topics important to an organization (e.g., government agencies, commercial entities) (e.g., as shown at 206 in FIG. 2).

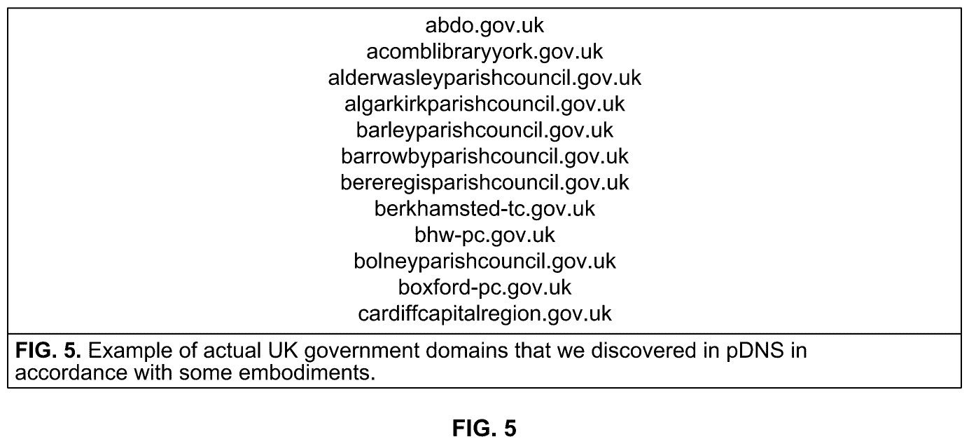

FIG. 5 provides an example of actual UK government domains that were discovered in pDNS in accordance with some embodiments.

According to the Internet Corporation for Assigned Names and Numbers (ICANN), there are a number of specialized TLDs, wherein, each tld is wholly managed by an organization. For example, these TLDs could be owned by a government organization, or sponsored by a commercial entity. With this information in mind, TIPS is also configured to automatically discover target seeds that use such TLDs. Taking the government of the United Kingdom (UK) for example, TIPS can gather all target seed SLDs that show a gov.uk suffix in pDNS. Specifically, FIG. 5 shows a subset of real and active SLDs that are used by various UK government agencies.

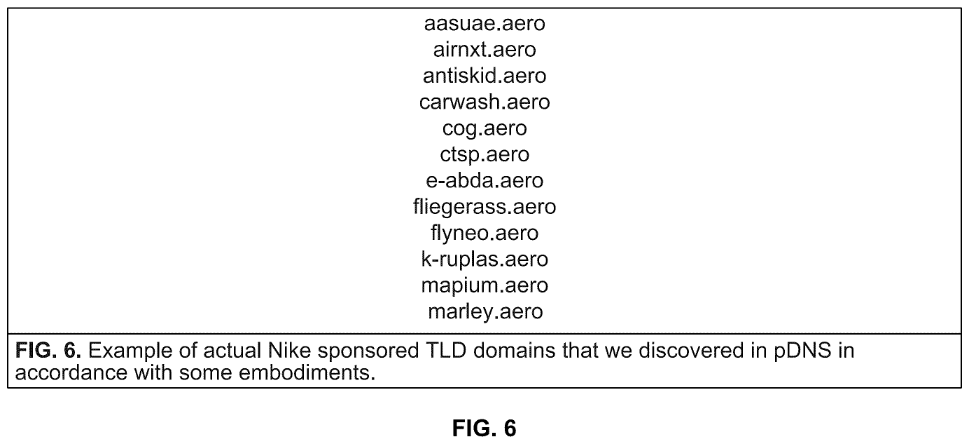

FIG. 6 provides an example of actual Nike sponsored TLD domains that we discovered in pDNS in accordance with some embodiments.

Similarly, organizations in the private sector have the legal ability to create and dedicate a TLD for their specific trademarks. This means that domains on the sponsored TLD are not available for public purchase. Only authorized individuals or entities within the organization governing the TLD can register the domains. Specifically, FIG. 6 shows an example of registered and active domains that we discovered in pDNS. These domains use the .aero TLD, sponsored by the Société Internationale de Télécommunications Aéronautiques (SITA), a multinational telecommunication services company that supports businesses in the air transport industry.

Discovering domain assets of a particular organization without a key textual indicator in the domain label, such as a specialized TLD, is technically challenging. For such scenarios, TIPS uses non-textual and more complex techniques to determine a domain owner's identity. Two examples of such techniques are DNS fingerprints and SSL certificate Subject Alternative Names (SANs). These techniques are explained in further detail below with respect to various embodiments.

Spatial Analysis with Computer Keyboards

In some embodiments, the spatial distance between the typosquat and authentic domain name is a factor that is used to determine whether a domain is a typosquat of a target seed. In an example implementation, TIPS calculates the spatial distance between the characters of the candidate domain name and the authentic domain name. Specifically, TIPS computes the Euclidean distance between two characters on a two-dimensional plane. In this example implementation, two dimensional and digital representations of computer keyboards are used to describe that space. For optimal performance, TIPS performs more efficiently when it uses keyboards that contain a manageable size of keys (e.g., approximately 100 keys), such as the QWERTY keyboard, which is the most common keyboard layout for English language users. Other applicable forms include QWERTY keyboard layouts for non-Latin scripts including Hangul (Korean alphabet), QWERTZ (popular layout in Germany), and AZERTY (most common layout in France).

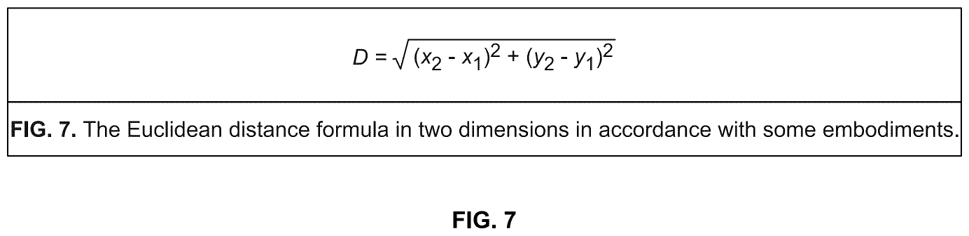

FIG. 7 provides an example of the Euclidean distance formula in two dimensions in accordance with some embodiments.

Specifically, FIG. 7 shows the mathematical expression of the Euclidean distance in two dimensions in accordance with some embodiments. In this representation: D is the Euclidean distance, and (x₁, y₁) and (x₂, y₂) are the Cartesian coordinates of the two points on a two-dimensional plane. The square and square root operators resolve the theoretical problem of having a negative scalar value (i.e., an outcome where the distance is a negative value).

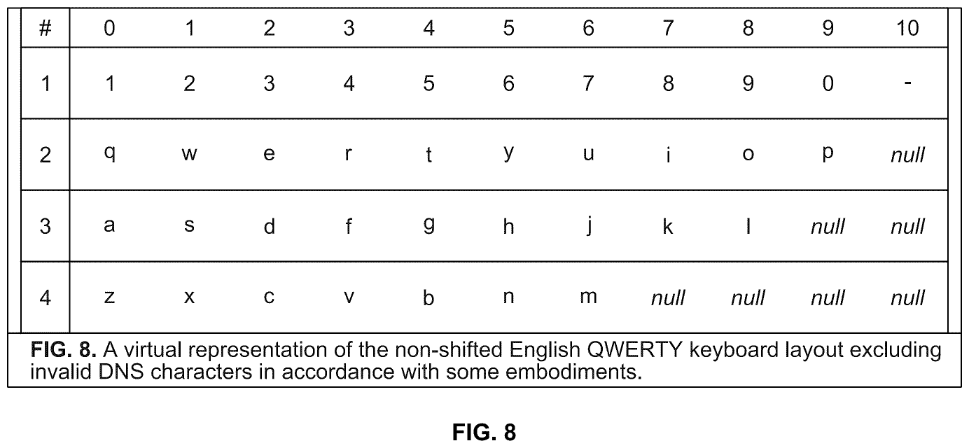

In an example implementation, a virtual form of the QWERTY English keyboard is generated in python, such as shown in FIG. 8. We've removed special characters that are typically found in a QWERTY keyboard, but not valid characters according to DNS RFC 1034. These characters include [,], ;, ‘, /, \grave{ }.

Using the formula described in FIG. 7, the Euclidean distance between the key “a” and the key “r” is calculated. The key “a” is equivalent to the coordinate (x, y) and “b” is positioned at (x, y) on the virtual QWERTY keyboard. Executing these two coordinate values through the formula shown in FIG. 7, the result is a Euclidean distance of X.

### Measuring the Cost of a Typo Mistake

As such, in this example implementation, TIPS automatically determines whether a domain is a possible typosquat by calculating its typo cost based on its relation to the target seed (e.g., as shown at 208 in FIG. 2). The typo cost indicates the severity of the typo mistake against the target seed. If the cost of a typosquat candidate domain is within the thresholds (e.g., predefined and/or configurable thresholds), that domain can be automatically classified as a typosquat. Specifically, the cost of a typo mistake is calculated in the form of a float value. To accomplish this, the above-described Euclidean distance equation uses the Euclidean distance and coefficients that are based on heuristic analysis of human keyboard behavior and actions.

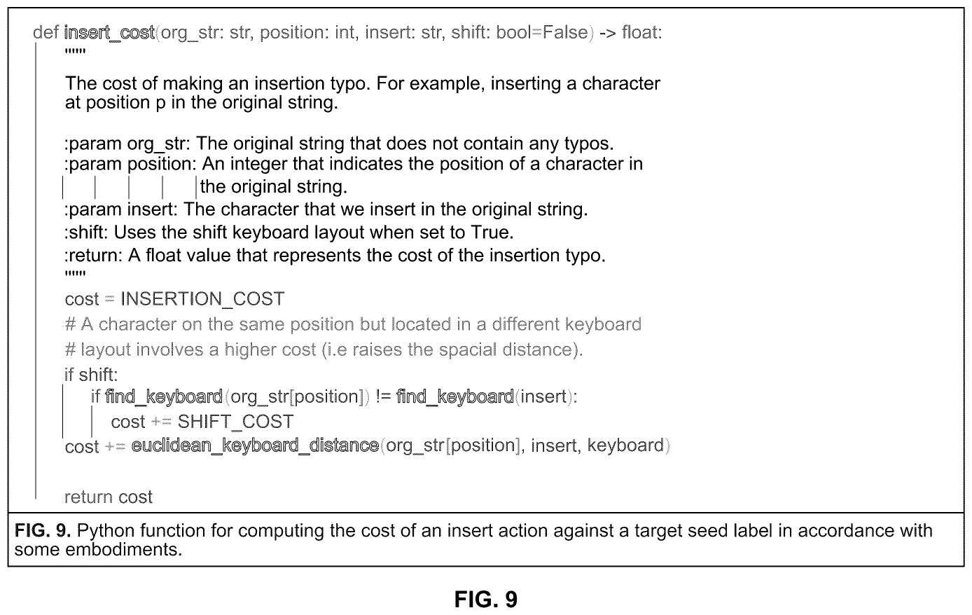

FIG. 9 illustrates a Python function for computing the cost of an insert action against a target seed label in accordance with some embodiments.

For example, there are three physical actions that Internet users typically perform on a computer keyboard: insert, substitute, and delete. As such, in this example implementation, the typo cost is measured by adding the Euclidean distance, action cost (e.g., insert), and additional costs dependent on other variables (e.g., a shifted keyboard has a higher cost). Specifically, FIG. 9 is a python example for creating a function that can perform this calculation in accordance with some embodiments. In this example implementation, the insertion cost and shift cost are constant values based on a heuristic analysis of keyboard actions.

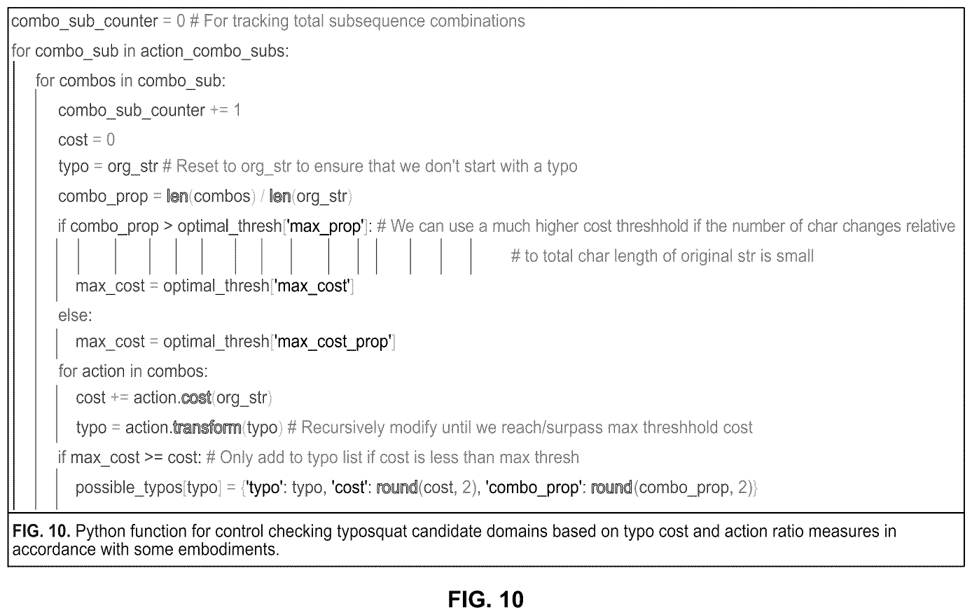

FIG. 10 Illustrates a Python function for control checking typosquat candidate domains based on typo cost and action ratio measures in accordance with some embodiments.

In addition, in this example implementation, the detection results are refined further by filtering out typosquats that show typo action ratios greater than a predefined configuration maximum value. The ratio is computed by taking the number of total actions performed on the target seed label relative to the total length of the same target seed. Shorter length target seeds require stricter ratio thresholds, because they have greater risks for false positives. The typo cost threshold correlates highly with the action ratio value of the typosquat candidate. The threshold value changes based on whether the candidate's action ratio value exceeds the configuration ratio threshold. Specifically, FIG. 10 demonstrates how control checking typosquat candidate domains can be performed by evaluating their typo cost and action ratio values in accordance with some embodiments.

As an example, if we discover a typosquat candidate with the domain name label infoblotx that infringes on Infoblox's brand infoblox, TIPS will accept it as a typosquat domain. Under normal circumstances, TIPS would have filtered out the candidate, because it produces a typo insert cost of 4.61. However, its action ratio is only 0.12 and lower than the configuration action ratio threshold, which means it warrants a higher typo cost threshold. This dynamic adjustment enables TIPS to achieve higher detection coverage levels as opposed to a simpler detection model.

### Pre-Generating Typos of Target Domains and Keyword Labels

Using the typo cost equation, all possible typos can be pre-generated for each authentic domain name or keyword string in the target seed database. This provides a powerful technique that enables TIPS to effectively detect typosquat domains at scale and in a very computationally efficient way. This techniques also makes it possible for TIPS users to protect their brand names by pre-registering highly relevant typosquat domains before they are even registered or activated (e.g., using a specialized feed for typosquat pre-registration as shown at 226 in FIG. 2).

In an example implementation, a step-by-step process of the typosquat pre-generation for a single target seed label is as follows in the Python programming language as will now be described below.
(1) For every position in the string, there exists the option of performing any combination of three actions: delete, insert, and substitute. In this example implementation, for “tiny” strings (e.g., a string length of less than five characters), only insert actions are performed (e.g., as based on experiments, deleting and substituting characters on tiny strings generally have a higher risk for false positives).
(2) Additionally, any target seed that is less than three characters long is removed in this example implementation (e.g., as such seeds are too short to produce any meaningful and accurate typosquat outputs based on experiments).
(3) Based on the above two rules, for each target seed, a list of applicable actions is automatically generated.
(4) Enumerating through every key in the virtual typing keyboard (e.g., QWERTY), a python object is generated for each character position of the original target string. This object includes the function for executing the action (e.g., delete, insert, or substitute), which effectively modifies the original string.
(5) TIPS determines the maximum threshold length of the subsequence (e.g., a number of elements in the subsequence) based on the length of the target seed string. In mathematics, a subsequence is a subset of another sequence and is formed by any number of or none of its elements. However, the order of the remaining elements is preferably maintained. For example, the sequence {A, B, D} is a subsequence of {A, B, C, D, E, F}. The maximum threshold length is pulled from a configuration data store that contains threshold definitions by string lengths. Shorter length target seeds will have a smaller length threshold. In simple terms, this means that the maximum number of typo actions possible on the target seed is equal to the maximum threshold value according to its configuration.
(6) For every interval x in [0, {max_subsequence_threshhold}], which is incremented by one, all possible x length subsequences of the elements from the iterable object produced in step 4 are computed.

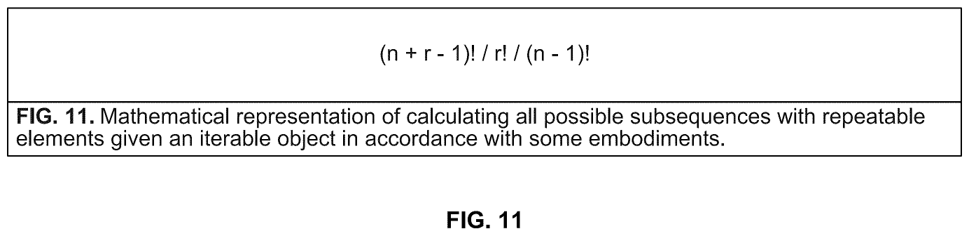

FIG. 11 provides a mathematical representation of calculating all possible subsequences with repeatable elements given an iterable object in accordance with some embodiments.
(7) Additionally, in step 6, we allow for repeatable elements. This is important because a typosquat can arise when a user performs an action (e.g., insert) multiple times, not just once. By generating subsequences with repeatable actions, additional typosquats that are naturally possible via human typo mistakes can be identified. This concept is mathematically represented by FIG. 11.
(8) Then, for every action combination within all possible subsequences for each of the intervals, the actions on the target seed label are performed.
(9) For every action combination, we calculate the ratio of the number of actions performed on the target seed to the length of the target seed label. If the ratio is less than the maximum ratio threshold according to the configuration, the maximum threshold cost value increases. Longer target seed labels with relatively low numbers of actions have more room for typo mistakes.
(10) After all typo actions are executed and we have modified the target seed label, as well as checked the ratios, we compare the total typo cost against the maximum allowed cost. If the total typo cost is within the threshold, the modified target seed label qualifies as a typosquat candidate.

### Identification Via Text Comparisons and Optimized Data Management

After we complete pre-generating typosquat domains for all target seeds, checking whether they were registered or activated in DNS is performed as will now be described. We join the dataset of domains observed in pDNS with the typosquat candidate domains that are stored in the typosquat archive table (e.g., as shown at 210 in FIG. 2). All domains that exist in the overlap move forward in the TIPS data pipeline.

In an example implementation, two different techniques are used to check for typosquat domains that resolved in DNS as described below.

As a first example technique, we compare if a domain in the pDNS dataset is equal to any typosquat domain in the typosquat archive table (e.g., mathematical expression: A==B). The result could either be a zero-cost typosquat or a regular typosquat.

As a second example technique, we join the two datasets again, but this time we check if any observed domain contains a subset equal to any typosquat domain label (e.g., does B contain A?). The mathematical expression for this method is A⊆B.

Although the concept explained above is relatively straightforward, the join operation can be computationally expensive to perform, especially if the datasets are large. As an example, daily views of a pDNS data table that includes observations from many enterprise networks can make up petabytes in data storage.

To manage the heavy computational workload, in an example implementation, an optimal data management solution is used to perform ultra-fast lookups in the typosquat archive using the domains from the pDNS dataset. Generally, this solution clusters the archive data by a key column with high cardinality. In our case, that column is the pre-generated typosquat domains. The data management system self-tunes itself according to query patterns for the typosquat archive and is resistant to skewed data. The management model ensures that the system produces consistent file sizes and avoids over and under partitioning. Additionally, TIPS intelligently launches and bootstraps computing nodes based on the size of the tasks that join against the typosquat archive table. This is a continuously growing archive of pre-generated typosquat domains of target seeds. As such, the disclosed computing and processing architecture allows TIPS to scale computing resources according to the task sizes.

Detecting Legitimate DNS Assets with DNS Fingerprints

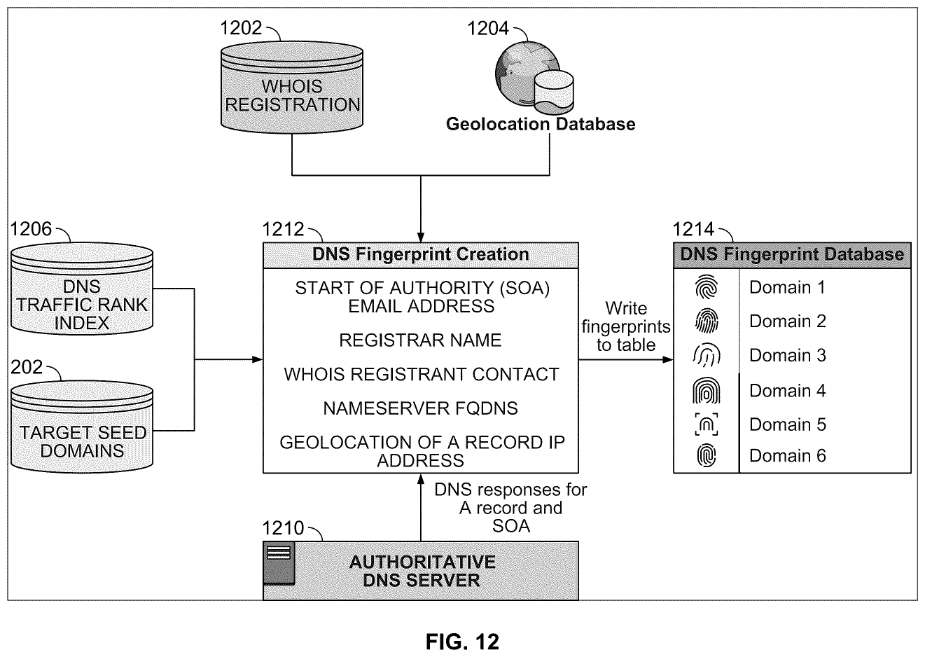

In some embodiments, TIPS automatically determines whether a candidate typosquat domain belongs to a legitimate organization by evaluating the DNS fingerprint of that domain. Specifically, TIPS generates a DNS identity for important domains, such as target seed inputs from business organizations, popular domains according to a DNS-specific traffic ranking index (e.g., as shown at 1206 in FIG. 12), and domains registered through reputable brand protection services.

The DNS fingerprints are then used to represent that identity. More specifically, a DNS fingerprint can be automatically generated using a combination of information that together, is not commonly repeated in DNS. In an example implementation, the fingerprint is a representation of the selection of DNS infrastructure supporting that domain, as well as its registrant. It includes DNS Resource Records (RRs) and information from WHOIS registration.

FIG. 12 illustrates a functional block diagram for automatically generating a DNS fingerprint for a domain using bits of information from both of these categories in accordance with some embodiments.

As part of the DNS fingerprint calculation, for each candidate typosquat domain, TIPS gathers related DNS name server and A record IP address by querying the domain's primary name server (i.e., authoritative DNS server as shown at 1210 in FIG. 12). This server holds the official records of the domain's IP address and other DNS RRs. We supplement the A record IP addresses with location information (e.g., city and country) using a reputable and highly precise IP geolocation database (e.g., as shown at 1204 in FIG. 12) containing a map between Classless Inter-Domain Routing (CIDR) values with physical location data points.

As also shown in FIG. 12, after DNS fingerprints are generated, using DNS Fingerprint Creation component as shown at 1212, for a set of domains (e.g., predetermined important domains as similarly described above, based on popularity of domains, enterprise user input, etc.), the results are stored in a DNS fingerprint database (e.g., stored in a DNS fingerprint table, such as shown at 1214 in FIG. 12). We refer to this DNS fingerprint table when we make comparisons between the fingerprints of typosquat candidate domains and the fingerprints of domains owned by legitimate entities. A matching fingerprint indicates a high probability for a false positive detection, and in such circumstances, the typosquat candidate can be filtered from the detection results.

Detecting Legitimate Assets with SSL Subject Alternative Names

Alternatively, TIPS also uses non-DNS datasets to discover domain assets owned by corporations that are not easily identifiable in DNS. Such domains are difficult to recognize in DNS, because they use notably different naming conventions compared to other domains belonging to the same organization, use completely different top-level domains, or show dissimilar WHOIS registration data (e.g., as stored at 1202).

As such, the disclosed technique utilizes the Multi-Domain Subject Alternative Name (SAN), a special kind of Secure Sockets Layer (SSL) certificate to find more domain assets belonging to an organization. This technique is effective because many organizations use the SAN field to add additional host names that they own, such as domains, wildcarded names, and IP addresses. This way, they can protect multiple domains that they own through a single SSL certificate.

However, without careful analysis, a SAN may contain other domains that are irrelevant to an organization. A common scenario is when multiple organizations use the same shared SSL certificate provided by a hosting provider for website support. This happens when the same IP address hosts multiple websites owned by different entities. Such certificates are installed, managed, and in some cases, also signed by the hosting provider.

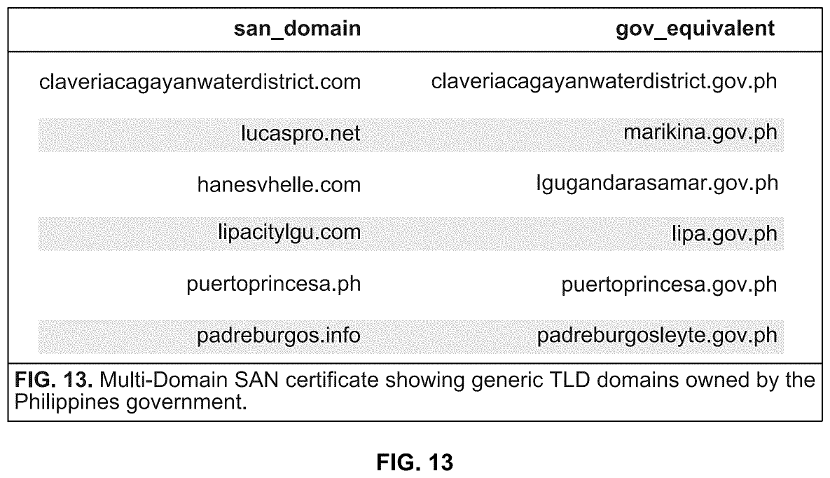

FIG. 13 shows a multi-Domain SAN certificate showing generic TLD domains owned by the Philippines government.

As such, in an example implementation, TIPS uses statistical summaries related to SSL certificates to determine whether a certificate is shared or dedicated. Specifically, FIG. 13 is an actual example of non-government TLD domains that TIPS discovered in SAN certificates that belong to the Philippines government. In some of the examples, the .gov.ph equivalent version of the SAN domain looks drastically different. However, we were still able to confirm the ownership via SSL certificate information using the disclosed technique.

### Finding Words in Textual Contents

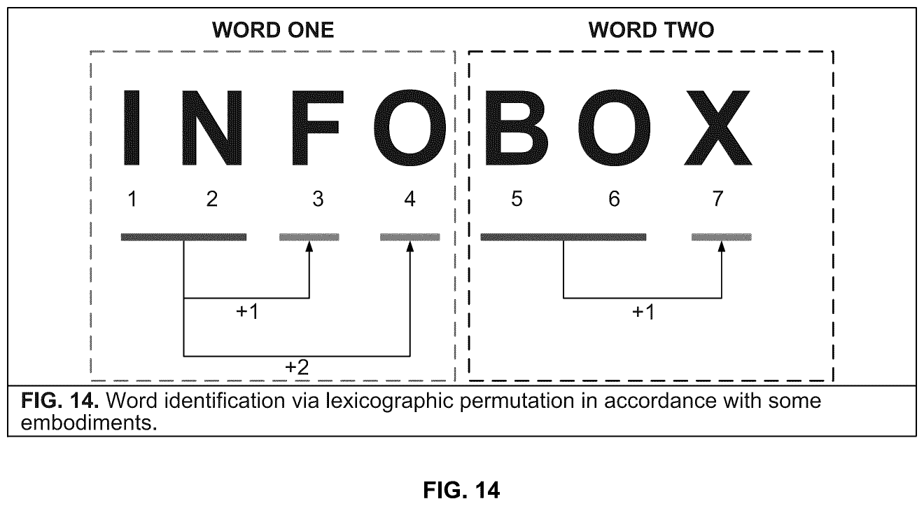

FIG. 14 illustrates how to automatically perform word identification via lexicographic permutation in accordance with some embodiments.

In some embodiments, a word identification technique used by TIPS is unique and highly accurate, comprehensive, and computationally fast. When TIPS looks for words that are contained in a text string, it begins its evaluation using the first two left characters of that string. Next, it grabs the next character to the right in increments of one character. From a mathematical point of view, we are generating lexicographic permutations of the characters in our input string. Specifically, FIG. 14 shows the order of evaluation on the example domain name label text string: INFOBOX. Two words are extracted here using the lexicographical permutation and incremental method: “INFO” and “BOX” as shown in FIG. 14.

In an example implementation, after each right shift, it compares the current string form (e.g., from the left-most character to the current position: {α₁, α₂, . . . , αₙ} where n is our current position) against our collection of word dictionaries. A word must be a minimum of three characters long. For our selection of dictionaries, we use a custom dataset and modules including web-based terms from the Natural Language Toolkit (NLT) corpus package. We repeat this incremental action and comparison against the dictionaries until we find the longest possible word, whose characters we then delete from the original input string. This cycle is repeated until there are no more characters left to evaluate.

### Anagram Contextual Changes

Many false positive typosquat domain name labels are anagrams. This occurs when there is a contextual change after rearranging the characters of the original target seed via a typosquat action. It can also happen when a typosquat label is combined with another label (e.g., combo typosquat domains). For example, although the domain label in bestbus.com is one letter away from the domain bestbuy.com, bestbus.com is not a valid typosquat of bestbuy.com because of its contextual difference and its high typocost.

Generally, the probability of an anagram is greater with combosquat and combo typosquat domains.

In an example implementation, TIPS uses the following process to automatically identify anagrams and filter them out from detection results so as to keep results as highly relevant as possible.
(1) TIPS uses the word extractor module (explained above) to find valid words in both the target seed label and typosquat candidate domain label.
(2) TIPS calculates the difference in words between both sets produced in stage (1).
(3) If the number of common words is equal to or greater than 2, then TIPS keeps the candidate, and if not, then TIPS does not keep the candidate.

Additionally, TIPS checks typosquat candidate domains to determine if they are a partial combosquat. This occurs when both the typosquat candidate domain label and target seed contain the same words, as well as short length non-word characters. For example, the keyword “solution” is generally a popular sub-label that many domain owners use in their domain names. If the TIPS system produces a typosquat candidate domain with the label ksolution.com based on the target seed zsolution.com, the detection can be filtered out. The typocost between the letters “k” and “z” is too great and there is not enough supporting evidence that both labels are contextually relevant.

In an example implementation, TIPS performs the below described process for automatically detecting partial combosquats and assessing whether they are false positives. In this example implementation, TIPS does not follow this procedure for target keywords (i.e., non-domain targets).
(1) If both the typosquat candidate domain label and target seed contain and share the same single word, that word is removed from both labels, and the remaining characters are assessed.
(2) In addition to removing the word, all hyphen characters are deleted. Domain owners commonly use this character as a delimiter. By removing the hyphens, the remaining characters can be more effectively assessed using the disclosed techniques.
(3) If the ratio of the number of remaining characters in the candidate domain against the number of remaining characters in the target exceeds a threshold (e.g., 0.34 or some other predetermined and/or configurable threshold), then the candidate domain is filtered out.
(4) In some cases, there can be exceptions to the above filters when, for example, the following conditions are met. These conditions can also be applied to short character combo typosquat candidate domain labels that are shorter than, for example, five characters long.
(i) The combo typosquat candidate starts with the zero-cost typosquat or regular typosquat appended by a hyphen delimiter string (python example: candidate_name.startswith(typosquat_label+‘-’)).
(ii) The combo typosquat candidate ends with the zero-cost typosquat or regular typosquat prefixed by a hyphen delimiter string (python example: candidate_name.endswith(‘-’+typosquat_label)).
(iii) The combo typosquat candidate contains the zero-cost typosquat or regular typosquat surrounded by hyphen characters (python example: ‘-’+typosquat_label+‘-’ in candidate_name).
(iv) For combo typosquat candidate labels shorter than 5 characters long, if the candidate label is greater than 50% of the length of the zero-cost or regular typosquat label, the candidate is filtered out.

### Proactive Typosquat Domain Registration

In addition to blocking typosquat domains via the DDR, another effective way to protect an organization's (e.g., enterprise's) domain and/or trademark is proactively registering them before cyber criminals have a chance to register or activate them.

However, purchasing all possible typosquat domains can be cost prohibitive. Organizations (e.g., enterprises) also need to consider the added costs from domain annual renewals and other management expenses. TIPS helps organizations purchase typosquat domains more intelligently by recommending typosquat domains that have the highest probability of being visited by Internet users because of natural typo mistakes. That probability is determined by a probability rating called typo_proximity for each pre-generated typosquat label within the typosquat archive table. The rating is calculated using the typosquat cost measure, as well as the typo action to target seed label ratio, described as combo_prop in the table below.

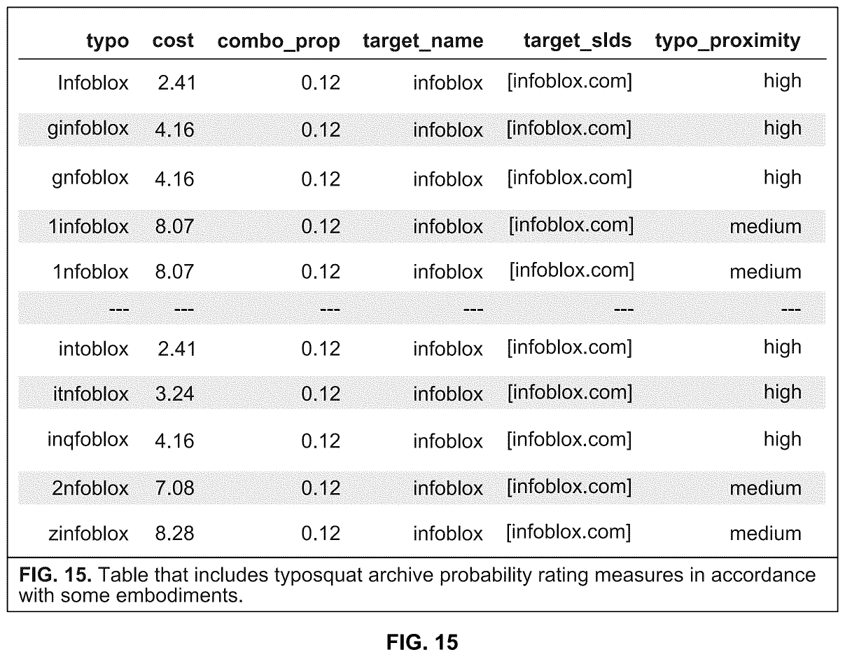

FIG. 15 is a table that includes typosquat archive probability rating measures in accordance with some embodiments.

Specifically, FIG. 15 is a table example of those ratings and the measures used to automatically calculate the probability value in accordance with some embodiments.

Based on the table shown in FIG. 15, an organization, such as Infoblox, can cost-effectively protect its domain brands proactively by purchasing domains with the same name labels that show a high typo proximity value. Those include lnfoblox, intoblox, and inqfoblox.

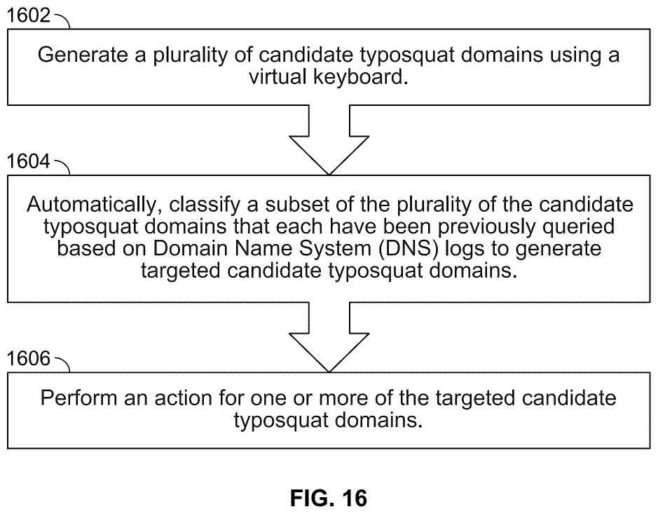

FIG. 16 is a flow diagram of a process for identification of typosquat variations in a passive domain name system (pDNS) in accordance with some embodiments. In some embodiments, a process as shown in FIG. 16 is performed by the components and techniques as similarly described above including, in an example implementation(s), the system embodiments and components described above with respect to FIGS. 2, 4, and 12.

The process begins at 1602. At 1602, a plurality of candidate typosquat domains are generated using a virtual keyboard.

At 1604, automatically classify a subset of the plurality of the candidate typosquat domains that each have been previously queried based on Domain Name System (DNS) logs to generate targeted candidate typosquat domains. For example, the classifying can include at least in part performing a Euclidean distance calculation using the virtual keyboard as a plane, such as similarly described above.

At 1606, an action is performed for one or more of the targeted candidate typosquat domains.

As an example, recommend registering the targeted candidate typosquat domains and/or automatically registering one or more of the targeted candidate typosquat domains can be performed.

As another example, sending the targeted candidate typosquat domains to a DNS threat feed can be performed.

As yet another example, automatically generating a malicious typosquat domains feed for typosquat domains classified as malicious can be performed.

As a further example, automatically adding typosquat domains classified as malicious to a domain block list can be performed (e.g., for each of the targeted candidate domains that satisfy the following criteria: (1) are not registered to a verified entity; and (2) exceed a threshold probability of typosquat based on a spatial cost calculation using a Euclidean distance between a candidate domain and authentic domain of the virtual keyboard as the plane).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
generate a plurality of candidate typosquat domains using a virtual keyboard;
automatically classify a subset of the plurality of the candidate typosquat domains that each have been previously queried based on Domain Name System (DNS) logs to generate targeted candidate typosquat domains, wherein the classifying includes at least in part performing a Euclidean distance calculation using the virtual keyboard as a plane; and
perform an action for one or more of the targeted candidate typosquat domains; and
a memory coupled to the processor and configured to provide the processor with instructions.

2. The system recited in claim 1, wherein the plurality of candidate typosquat domains includes second level domains and subdomains.

3. The system recited in claim 1, wherein the virtual keyboard includes a QWERTY format and/or a format for non-English languages.

4. The system recited in claim 1, wherein the virtual keyboard includes a QWERTY format, and wherein a Euclidean distance calculation is performed between a first candidate domain and a first authentic domain.

5. The system recited in claim 1, wherein the DNS logs include passive DNS (pDNS) including raw DNS logs and/or zone archive files.

6. The system recited in claim 1, wherein the processor is further configured to:
automatically classify a subset of a plurality of candidate combo typosquat candidates that each have been previously queried based on Domain Name System (DNS) logs to generate targeted candidate combo typosquat candidates.

7. The system recited in claim 1, wherein the processor is further configured to:
recommend registering the targeted candidate typosquat domains and/or automatically register one or more of the targeted candidate typosquat domains.

8. The system recited in claim 1, wherein the processor is further configured to:
send the targeted candidate typosquat domains to a DNS threat feed.

9. The system recited in claim 1, wherein the processor is further configured to:
automatically generate a malicious typosquat domains feed for typosquat domains classified as malicious.

10. The system recited in claim 1, wherein the processor is further configured to:
automatically add typosquat domains classified as malicious to a domain block list.

11. The system recited in claim 1, wherein the processor is further configured to:
automatically add typosquat domains classified as malicious to a domain block list for the targeted candidate typosquat domains that are not registered to a verified entity.

12. The system recited in claim 1, wherein the processor is further configured to:
automatically add typosquat domains classified as malicious to a domain block list for each of the targeted candidate typosquat domains that satisfy a following criteria: (1) are not registered to a verified entity; and (2) exceed a threshold probability of typosquat based on a spatial cost calculation using a Euclidean distance between a candidate domain and authentic domain of the virtual keyboard as the plane.

13. The system recited in claim 1, wherein the processor is further configured to:
identify regular typosquats, exact label typosquats, combosquats, and/or combo typosquats from the targeted candidate typosquat domains.

14. The system recited in claim 1, wherein the processor is further configured to:
filter the targeted candidate typosquat domains using one or more filters to reduce false positives.

15. The system recited in claim 1, wherein the processor is further configured to:
receive input of one or more domains associated with an entity to use a domain seed list;
filter the targeted candidate typosquat domains using one or more filters to reduce false positives, wherein the filtering includes one or more of the following: word-based filtering for contextual meaning; DNS fingerprint-based filtering, and/or textual analysis-based filtering; and
identify one or more malicious typosquat domains from the targeted candidate typosquat domains.

16. The system recited in claim 1, wherein the processor is further configured to:
filter at least one of the targeted candidate typosquat domains using SAN SSL certificates to determine whether the at least one targeted candidate typosquat domain belongs to a legitimate organization, and if so, filter out the at least one candidate typosquat domain.

17. A method, comprising:
generating a plurality of candidate typosquat domains using a virtual keyboard;
automatically classifying a subset of the plurality of the candidate typosquat domains that each have been previously queried based on Domain Name System (DNS) logs to generate targeted candidate typosquat domains, wherein the classifying includes at least in part performing a Euclidean distance calculation using the virtual keyboard as a plane; and
performing an action for one or more of the targeted candidate typosquat domains.

18. The method of claim 17, wherein the plurality of candidate typosquat domains includes second level domains and subdomains.

19. The method of claim 17, wherein the virtual keyboard includes a QWERTY format and/or a format for non-English languages.

20. A computer program product embodied in a non-transitory computer readable medium and comprising computer instructions for:
generating a plurality of candidate typosquat domains using a virtual keyboard;
automatically classifying a subset of the plurality of the candidate typosquat domains that each have been previously queried based on Domain Name System (DNS) logs to generate targeted candidate typosquat domains, wherein the classifying includes at least in part performing a Euclidean distance calculation using the virtual keyboard as a plane; and
performing an action for one or more of the targeted candidate typosquat domains.
